(19) United States
(12) Patent Application Publication
(10) Pub. No.: US 2026/0167314 A1
(43) Pub. Date: Jun. 18, 2026

(54) A CLAMP BRACKET FOR SUPPORTING AN ELECTRIC OUTBOARD MOTOR, AND AN ELECTRIC OUTBOARD MOTOR COMPRISING SUCH A CLAIM BRACKET

(71) Applicant: EVOY AS, FLORØ (NO)

(72) Inventors: Magne Audun Askeland, Sæbøvågen (NO); Arne Leif STAVØSTRAND, Florø (NO); Marius DYRSETH, Florø (NO); Inge Sten HELLEVANG, Florø (NO); Magnus Carl MIDTBØ, Florø (NO)

(21) Appl. No.: 18/703,334

(22) PCT Filed: Nov. 10, 2022
(86) PCT No.: PCT/NO2022/050255

§ 371 Date: Apr. 20, 2024

(30) Foreign Application Priority Data
Nov. 12, 2021 (NO) 20211365

(51) Int. Cl. B63H 20/06; B63H 20/28

(52) U.S. Cl. CPC B63H 20/06; B63H 20/285

(57) ABSTRACT

The present invention relates to a clamp bracket (20) for supporting an electric outboard motor (30) mountable to a boat (10), wherein the clamp bracket (20) comprises a cooling water intake (22) for supply of external cooling water from water (16) surrounding the boat (10) and to the electric outboard motor (30). Also disclosed is an electric outboard motor (30) supported by such a clamp bracket (20) wherein the cooling water intake (22) of the clamp bracket (20) is connected to a motor housing (38) of the electric outboard motor (30), and wherein the motor housing (38) of the electric outboard motor (30) comprises a three-way selector valve (34) for switching supply of cooling water to a cooling circuit between the cooling water intake (22) of the clamp bracket (20) and a cooling water intake (32) in a lower leg (36) of the electric outboard motor (30).

### FIELD OF THE INVENTION

The present invention relates to a clamp bracket for supporting an electric outboard motor mountable to a boat, and an electric outboard motor comprising such a clamp bracket.

### BACKGROUND OF THE INVENTION

Existing technology for providing water cooling on traditional internal combustion outboard engines as well as current engines refitted for electrical powerheads, rely on seawater inlet(s) located in a lower leg of the motor.

In order to eliminate the chances of hitting bottom with an outboard motor, the motor can be tilted up to an elevated position. This helps when traveling through shallow waters where there may be debris that could potentially damage the motor as well as the propeller. The motor can also be tilted completely out of the water to prevent such as barnacle growth when harboured. In this dry position, the outboard water intake will also be rendered inoperative.

When not in use the outboard motor is normally tilted up to an elevated position, which may be a problem for particularly electric outboard motors.

### DISCLOSURE OF THE STATE OF ART

Cooling systems for marine inboard and outboard motors are well known.

JP2014239607 A2 discloses a battery cooling mechanism for electric outboard motor, wherein the battery pack is placed within the boat and receives externally supplied tap water as cooling water.

US2015232163 A1 discloses a boat drive with a cooling circuit. The power supply to the electric motor and to the motor electronics is realized by means of a battery which is arranged at a distance from the outboard drive, in the interior of the boat. Water is drawn in via a coolant inlet and flows through a line section and cools the electric motor and the motor electronics, and subsequently the battery. The heated coolant is then recirculated and discharged via a coolant outlet.

Reference is also made to JPH07-323894 A, US 5045001 A, US 5304079 A and JP2010-228534 A.

### OBJECTS OF THE PRESENT INVENTION

The present invention adds one or several submerged water intakes to an electric outboard motor, to prevent lack of cooling for internal components. The water intake can be fitted with strainers to prevent foreign objects to be let into the cooling circuit(s).

Electric outboard motor operation depends on reliable supply of cooling water from submerged water inlets. The present invention solves the potentially hazardous condition of overheating batteries and/or internal components of an electric outboard motor.

Further, the benefit with the present invention is that it is all mounted on the electric outboard motor or the associated clamp bracket and there is thus no need for seawater intake through the hull of the boat.

Electrical outboard engines often rely on cooling the batteries or other components for some time after operation or when charging. Tilting the water intake out of the water may prevent component cooling and could make charging the batteries hazardous. Hence, an object of the present invention is to cool and to avoid overheating of the electric outboard motor when the cooling water intake is tilted out of the water.

### SUMMARY OF THE INVENTION

According to a first aspect of the invention, a clamp bracket is provided for supporting an electric outboard motor mountable to a boat, wherein the clamp bracket comprises a cooling water intake for supply of external cooling water from water surrounding the boat and to the electric outboard motor.

The cooling water intake can in a first embodiment be an internally mounted tube extending through a boring running from an upper part of the clamp bracket and to a lower part of the clamp bracket.

The cooling water intake can in a second embodiment be an externally mounted tube connected between an upper part of the clamp bracket and a lower part of the clamp bracket. The tube of the cooling water intake can be connected externally to the clamp bracket by clamps.

The cooling water intake comprises a tube running down into the surrounding water.

A lower part of the tube to the cooling water intake can comprise a strainer.

At least a lower part of the tube to the cooling water intake can be extendable.

According to a second aspect of the invention, an electric outboard motor is provided supported by such a clamp bracket, wherein the cooling water intake of the clamp bracket is connected to a motor housing of the electric outboard motor, and wherein the motor housing of the electric outboard motor comprises a three-way selector valve for switching supply of cooling water to a cooling circuit between the cooling water intake of the clamp bracket and a cooling water intake in a lower leg of the electric outboard motor.

The motor housing of the electric outboard motor may further comprise an electrically driven displacement pump to draw water through the cooling water intake of the clamp bracket.

The three-way valve is preferably arranged to supply cooling water to the cooling circuit from the cooling water intake of the clamp bracket when the electric outboard motor is tilted up, and to supply cooling water to the cooling circuit from the cooling water intake in the lower leg of the electric outboard motor when the electric outboard motor is tilted down into the water.

The motor housing of the electric outboard motor may comprise one or more batteries, charger and/or other water-cooled components.

### DESCRIPTION OF THE FIGURES

Embodiments of the present invention will now be described, by way of example only, with reference to the following figures, wherein:

FIG. 1 shows an electric outboard motor mounted by a clamp bracket to an aft end of a boat.

FIG. 2 shows the electric outboard motor of FIG. 1 tilted out of the water.

FIGS. 3a and 3b show a first embodiment of a clamp bracket for the electric outboard motor.

FIGS. 4a and 4b show a second embodiment of a clamp bracket for the electric outboard motor.

### DESCRIPTION OF PREFERRED EMBODIMENTS OF THE INVENTION

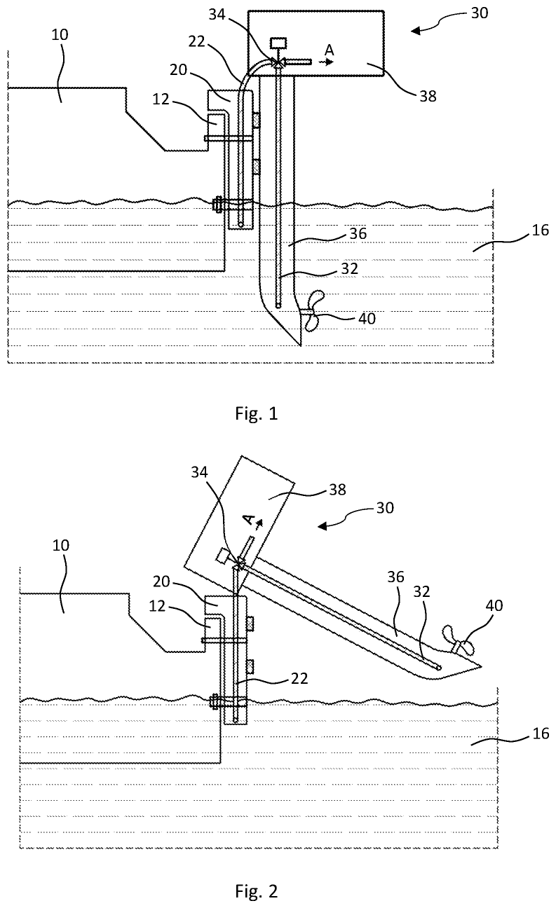

FIGS. 1 and 2 show schematically an electric outboard motor 30 supported and mounted by a motor mounting bracket such as a clamp bracket 20 to a transom 12 on an aft end of a boat 10. The boat 10 is shown floating in a body of water 16. In FIG. 1 the electric outboard motor 30 is tilted down into the surrounding water 16, and in FIG. 2 the electric outboard motor 30 is tilted up from the surrounding water 16. The electric outboard motor 30 comprises a motor housing 38 accommodating one or more batteries to power the motor and a charger for charging the battery. The motor housing 38 may also accommodate other water-cooled components and regular components needed for driving the electrical outboard motor 30.

The electric outboard motor 30 further comprises in a known manner a lower leg 36 with a propeller 40 and a cooling water intake 32 for supply of cooling water when the electric outboard motor 30 is tilted down into the surrounding water 16. The cooling water intake 32 in the lower leg 36 can be said to be a first cooling water intake.

Traditionally electric outboard motors rely on seawater intake through the cooling water intake 32 at the lower leg 36, but this is above the waterline when the motor is tilted up during stay in for instance a harbor. To cool the batteries, charger and/or other water-cooled components when the electric outboard motor 30 is tilted up, the present invention uses a three-way selector valve 34 in combination with a second cooling water 22 intake in the clamp bracket 20 to supply external cooling water to a cooling circuit in the motor housing 38. The cooling circuit is not shown, but the arrows A in FIGS. 1 and 2 indicates the supply of cooling water to the cooling circuit. The benefit with this solution is that it is all mounted on the electric outboard motor 30 and there is no need for seawater intake through the hull of the boat 10.

At the electric outboard motor 30, the cooling water intake 22 of the clamp bracket 20 and the cooling water intake 32 in the lower leg 36 are connected to an engine internal arrangement of internal valves and pumps to make the overall system failsafe, depending on which one of the cooling water intakes that is in the submerged position.

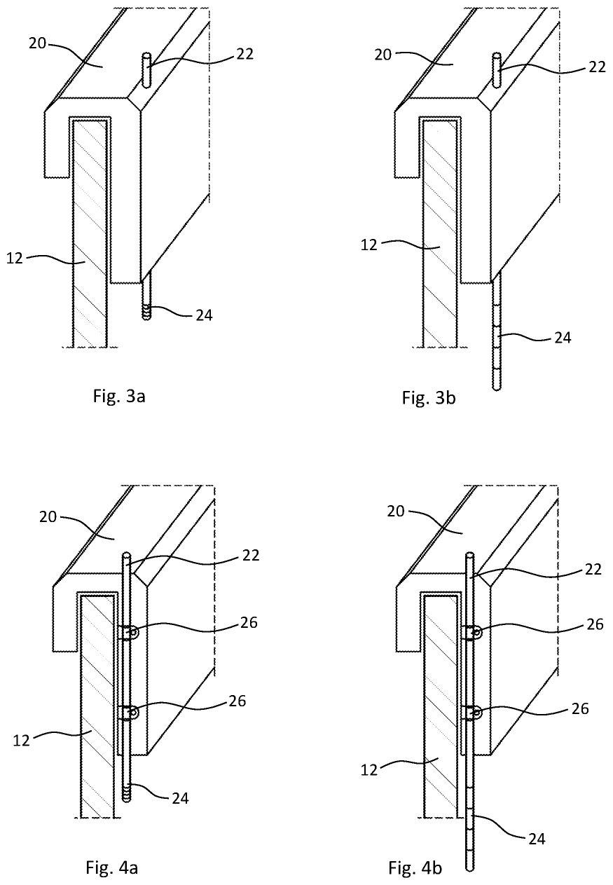

The three-way selector valve 34 is accommodated in the motor housing 38. The motor housing 38 further comprises an electrically driven displacement pump. The displacement pump is needed to be able to draw the water from below pump level. FIGS. 3a,3b and 4a,4b show a first and second embodiment of the clamp bracket 20 for the outboard motor 30. The clamp bracket 20 is mountable to the transom 12 on the aft of the boat 10, and supports the electric outboard motor 30.

The clamp bracket 20 is as shown in a known manner at least partially U-shaped for mounting to the upper part of the transom 12, and has hinges allowing tilting of the electric outboard motor 30. The clamp bracket 20 comprises a cooling water intake 22, which can be said to be the second cooling water intake, and that runs up to and during use is connected to the three-way selector valve 34 in the motor housing 38.

The clamp bracket 20 can however have a U-shape or a L-shape (upside down) shape. The clamp bracket 20 can be clamped and/or bolted to the transom 12, in the usual manner.

In the first embodiment, shown in FIGS. 3a and 3b, the cooling water intake 22 in the clamp bracket 20 is an internal mounted tube running through a boring in the clamp bracket 20 from an upper part to a lower part of the clamp bracket 20.

In the second embodiment, shown in FIGS. 4a and 4b, the cooling water intake 22 in the clamp bracket 20 is an external mounted tube running on an outside of the clamp bracket 20 from an upper part to a lower part of the clamp bracket 20.

The lower part 24 of the tube can be expandable and may be a telescopic tube, as shown in FIGS. 3b and 4b, to ensure that the lower part of the tube is inserted in the surrounding water 16.

The cooling water intake 22 of the clamp bracket 20 will normally not be used when travelling, at least not at high speeds, as the clamp bracket 20 during high speeds will not be submerged, even with the tube extended.

1. A clamp bracket (20) for supporting an electric outboard motor (30) mountable to a boat (10), characterized in that the clamp bracket (20) comprises a cooling water intake (22) for supply of external cooling water from water (16) surrounding the boat (10) and to the electric outboard motor (30).

2. The clamp bracket (20) according to claim 1, wherein the cooling water intake (22) is an internally mounted tube extending through a boring running from an upper part of the clamp bracket (20) and to a lower part of the clamp bracket (20).

3. The clamp bracket (20) according to claim 1, wherein the cooling water intake (22) is an externally mounted tube connected between an upper part of the clamp bracket (20) and a lower part of the clamp bracket (20).

4. The clamp bracket (20) according to claim 3, wherein the tube of the cooling water intake (22) is connected externally to the clamp bracket (20) by clamps (26).

5. The clamp bracket (20) according to claim 1, wherein the cooling water intake (22) comprises a tube running down into the surrounding water (16).

6. The clamp bracket (20) according to claim 5, wherein a lower part (24) of the tube to the cooling water intake (22) comprises a strainer.

7. The clamp bracket (20) according to claim 5, wherein at least a lower part (24) of the tube to the cooling water intake (22) is extendable.

8. An electric outboard motor (30) supported by a clamp bracket (20) according to claim 1, characterized in that the cooling water intake (22) of the clamp bracket (20) is connected to a motor housing (38) of the electric outboard motor (30), and wherein the motor housing (38) of the electric outboard motor (30) comprises a three-way selector valve (34) for switching supply of cooling water to a cooling circuit between the cooling water intake (22) of the clamp bracket (20) and a cooling water intake (32) in a lower leg (36) of the electric outboard motor (30).

9. The electric outboard motor (30) according to claim 8, wherein the motor housing (38) of the electric outboard motor (30) comprises an electrically driven displacement pump to draw water through the cooling water intake (22) of the clamp bracket (20)

10. The electric outboard motor (30) according to claim 8, wherein the three-way valve (34) is arranged to supply cooling water to the cooling circuit from the cooling water intake (22) of the clamp bracket (20) when the electric outboard motor (30) is tilted up, and to supply cooling water to the cooling circuit from the cooling water intake (32) in the lower leg (36) of the electric outboard motor (30) when the electric outboard motor (30) is tilted down into the water (16).

11. The electric outboard motor (30) according to claim 8, wherein the motor housing (38) of the electric outboard motor (30) comprises one or more batteries, charger and/or other water-cooled components.

12. An electric outboard motor (30) supported by a clamp bracket (20) according to claim 2, characterized in that the cooling water intake (22) of the clamp bracket (20) is connected to a motor housing (38) of the electric outboard motor (30), and wherein the motor housing (38) of the electric outboard motor (30) comprises a three-way selector valve (34) for switching supply of cooling water to a cooling circuit between the cooling water intake (22) of the clamp bracket (20) and a cooling water intake (32) in a lower leg (36) of the electric outboard motor (30).

13. An electric outboard motor (30) supported by a clamp bracket (20) according to claim 3, characterized in that the cooling water intake (22) of the clamp bracket (20) is connected to a motor housing (38) of the electric outboard motor (30), and wherein the motor housing (38) of the electric outboard motor (30) comprises a three-way selector valve (34) for switching supply of cooling water to a cooling circuit between the cooling water intake (22) of the clamp bracket (20) and a cooling water intake (32) in a lower leg (36) of the electric outboard motor (30).

14. An electric outboard motor (30) supported by a clamp bracket (20) according to claim 4, characterized in that the cooling water intake (22) of the clamp bracket (20) is connected to a motor housing (38) of the electric outboard motor (30), and wherein the motor housing (38) of the electric outboard motor (30) comprises a three-way selector valve (34) for switching supply of cooling water to a cooling circuit between the cooling water intake (22) of the clamp bracket (20) and a cooling water intake (32) in a lower leg (36) of the electric outboard motor (30).

15. An electric outboard motor (30) supported by a clamp bracket (20) according to claim 5, characterized in that the cooling water intake (22) of the clamp bracket (20) is connected to a motor housing (38) of the electric outboard motor (30), and wherein the motor housing (38) of the electric outboard motor (30) comprises a three-way selector valve (34) for switching supply of cooling water to a cooling circuit between the cooling water intake (22) of the clamp bracket (20) and a cooling water intake (32) in a lower leg (36) of the electric outboard motor (30).

16. An electric outboard motor (30) supported by a clamp bracket (20) according to claim 6, characterized in that the cooling water intake (22) of the clamp bracket (20) is connected to a motor housing (38) of the electric outboard motor (30), and wherein the motor housing (38) of the electric outboard motor (30) comprises a three-way selector valve (34) for switching supply of cooling water to a cooling circuit between the cooling water intake (22) of the clamp bracket (20) and a cooling water intake (32) in a lower leg (36) of the electric outboard motor (30).

17. An electric outboard motor (30) supported by a clamp bracket (20) according to claim 7, characterized in that the cooling water intake (22) of the clamp bracket (20) is connected to a motor housing (38) of the electric outboard motor (30), and wherein the motor housing (38) of the electric outboard motor (30) comprises a three-way selector valve (34) for switching supply of cooling water to a cooling circuit between the cooling water intake (22) of the clamp bracket (20) and a cooling water intake (32) in a lower leg (36) of the electric outboard motor (30).
